(19) United States
(12) Patent Application Publication
(10) Pub. No.: US 2009/0148557 A1
(43) Pub. Date: Jun. 11, 2009

(54) Foamed food comprising soybean flour as the main component

(75) Inventors: Mayumi Higashino, Yamagata (JP); Kimimasa Hata, Kanagawa (JP); Akihiro Nishioka, Yamagata (JP); Mika Nishioka, Yamagata (JP); Kiyohito Koyama, Yamagata (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Days Nutrition , Inc., Macon, GA (US)

(21) Appl. No.: 10/584,835

(22) PCT Filed: Sep. 27, 2005
(86) PCT No.: PCT/JP05/18235

§ 371 Date: Jun. 27, 2006

(30) Foreign Application Priority Data
Sep. 30, 2004 (JP) 2004-286604
Oct. 1, 2004 (JP) 2004-290077

(51) Int. Cl. A21D 13/04; A21D 8/02

(52) U.S. Cl. 426/46; 426/550

(57) ABSTRACT

Disclosed are dough for foamed food and foamed food such as bread, containing soybean flour as a main raw material, with containing neither wheat flour gluten nor silk fibroin, capable of forming a sponge-like crosslinked network structure, and dough for foamed food and foamed food such as bread, containing soybean flour as a main raw component such that the amount of the soybean flour is more than 50 parts by weight and the amount of the wheat flour is less than 50 parts by weight with the total of the soybean flour and the wheat flour being 100 parts by weight.

### TECHNICAL FIELD

The present invention relates to a method of forming a crosslinked network structure from dough including soybean flour, yeast or a foaming agent, and water as main materials without blending wheat flour, and optionally a quality improver or flavor improver as a side raw material, to a dough for foamed food obtained by the method, having a viscosity lower than that conventionally attained, and to foamed food using such dough, such as bread, composed mainly of soybean flour. The present invention also relates to foamed food, such as bread, containing a large amount of soybean flour, in which more than 50 parts by weight of soybean flour and less than 50 parts by weight of wheat flour component are used in bread dough in a manner such that a crosslinked network structure is formed. More particularly, the present invention relates to a foamed food, such as bread, and a novel method of producing the same each of which enables the formation of an excellent crosslinked network structure, even when soybean powder is used as a main material in amounts of more than 50% by weight, particularly 80% by weight or more, more particularly 90% by weight or more, in despite of the fact that it has been difficult to charge a large amount of soybean flour by means of the conventional bread making method.

### BACKGROUND ART

In the past for long time, wheat flour has been used for foamed food such as bread. It is known that the reason why wheat flour has been used as a material is because of its viscoelasticity due to gluten after being allowed to contain water and being mixed. The gluten's viscoelasticity is ascribable to properties of newly forming crosslinked network structure such as an S—S bond when two proteins, gliadin and glutenin, colliding against each other during mechanical mixing in a hydrated state. When air bubbles being formed by yeast or the like, due to low viscosity with components other than the wheat flour gluten, the process of growth and deformation of the air bubbles are promoted in these components. When the air bubbles having grown large, although the thickness of the wall of each of the air bubbles is decreased to some extent, skeletons with large air bubbles and a unique texture are generated because of the gluten component existing that maintains their structures without being crushed. However, flours of crops other than wheat, such as nonglutinous rice, barley, rye, mylo, and corn and soybean flour contain no gluten that forms such a viscous component. Therefore, it has been considered that foamed food, typically, bread could not be prepared from a main material that is composed of 100% soybean without adding wheat flour. Accordingly, generally soybean has long since been used in processed foods that have no foamed structure, such as soybean curd (tofu), bean paste, fermented soybeans, soy sauce, or soybean milk but soybean has scarcely been processed into foamed food such as bread.

Conventionally, soybean flour has been used as a flavor improver or a quality improver by being mixed in wheat flour bread. For example, JP-A-2002-142680 (Baked confectionary and method of producing the same), JP-A-2001-211813 (Quality improving composition for bread and method of producing bread using the composition), and JP-A-2002-238442 (Mixture, premix, bread, and method of producing bread) are all intended to improve the quality by mixing a small amount of soybean powder or soybean protein powder in wheat flour bread or cake. Further, JP-A-2000-300156 (Quality improver for breadmaking) and JP-A-2000-83572 (Cake-like food using soybean food material) have the same object.

Further, JP-A-11-243844 (Production of bread) is intended to produce breads having high nutritional values or prevent aging of bread by addition of soybean protein to wheat flour bread; that is, soybean flour is added with a view only to supplementing what the conventional wheat flour bread lacks.

For products other than bread products, JP-A-2001-057842 (Foaming agent for cake and food using the same) is intended to utilize a soybean protein component as a foaming agent for cake, and JP-A-2000-32903 (Cookie-like food using soybean food material) is intended to provide soft and crisp feeling by addition of soybean particles to bread made from wheat flour. Their objects remain within the range of the conventional improvement in the quality of confectioneries. Besides, some of commercially available bread is found to contain ground soybean or soybean particles. However, both are blended as side materials with wheat flour bread.

As stated above, generally, soybean has long since been used for processed food that has no foamed structure, such as soybean curd, bean paste, fermented soybeans, soy sauce, or soybean milk, but soybean has scarcely been processed into foamed food such as bread. However, health components such as isoflavone, vitamin E, food fiber, and good vegetable protein contained in soybean have attracted attention and are often used in small amounts in food that are made from wheat flour as a material, such as bread, sponge cake, muffin, rusk, and doughnut as the dietary life has changed into European style and diversified. It has already been known, as described in each of the above-mentioned patent documents, that soybean flour mixes with foamed food, such as wheat flour bread, to be a flavor improver or a quality improver.

Thus, there has been bread that contains a small amount of soybean flour as a side material. However, in bread making by means of production method conventionally realized, the amount of soybean material that the bread can contain is up to substantially the same amount as that of the wheat flour to be used. It has been considered to be impossible to have the soybean material contained in bread in a still larger amount than that amount. This is because, with a large amount, i.e., more than 50% by weight of soybean material charged, sufficient mixing does not occur even by kneading, resulting in dough lacking viscoelasticity without gluten to be formed.

### DISCLOSURE OF THE INVENTION

A first object of the present invention is to develop a foamed food that is made from soybean flour having unique palatability as a main material, without using wheat flour or gluten, and is foamed with a foaming ratio (a ratio of volumes before and after foaming) being set substantially the same as that of conventional wheat flour-derived bread in a foaming process in which air bubbles are generated and grow, thereby a sponge-like crosslinked network structure made of soybean flour as a main raw material forming.

A second object of the present invention is to develop a foamed food containing soybean flour as a main raw material in combination with wheat flour, the foamed food including soybean's good palatability and making the best of heath components that soybean has.

According to a first aspect of the present invention, there is provided a method of producing a crosslinked network structure made from soybean flour as a main raw material comprising: mixing and kneading a mixture of raw materials containing soybean flour, yeast or a foaming agent, and water as main raw materials, containing neither wheat flour gluten nor silk fibroin and optionally containing a flavor improver or quality improver as a side raw material to prepare viscoelastic dough in a manner such that the mixed raw materials is dispersed and mixed uniformly, and that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water, thereby the dough having a viscosity of 1×10³ to 7.8×10⁴ (Pa·s), or preferably 7×10³ to 5.2×10⁴ (Pa·s) at a shear rate of 0.01 (/s) at a shear rate of 0.01 (/s); foaming and extending the obtained dough by fermentation action of the yeast or by foaming action of the foaming agent; and subjecting the foamed and extended dough to a heat treatment.

According to the first aspect of the present invention, there is also provided a viscoelastic dough containing soybean flour as a main raw material for foamed food comprising: a mixture of raw materials containing soybean flour, yeast or a foaming agent, and water as main raw materials, containing neither wheat flour gluten nor silk fibroin and optionally containing a flavor improver or quality improver selected from the group consisting of sugars, oils and fats, milk products, egg, table salt, rice flour, barley flour, starch such as starch powder, tapioca flour, or corn starch, and sorghum flour, as a side raw material, the raw materials being dispersed and mixed uniformly in a manner such that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water by way of mixing and kneading, thereby having a viscosity of 1×10³ to 7.8×10⁴ (Pa·s) at a shear rate of 0.01 (/s).

According to the first aspect of the present invention, there is also provided a powdery raw material for basic preparation comprising: soybean flour as raw material; and at least one member selected from the group consisting of table salt, powdered sugars, powdered milk products, powdered oils and fats, powdered egg, rice flour, barley flour, starch, and sorghum flour as a flavor improver or quality improver in combination with the soybean flour as raw material containing neither wheat flour gluten nor silk fibroin.

According to the first aspect of the present invention, there is also provided a foamed food containing soybean flour as a main raw material obtained by way of: foaming and expanding the aforementioned dough for foamed food by fermentation action by yeast or foaming action by a foaming agent; then molding the resultant; and subjecting the resultant to a heat treatment to form a crosslinked network structure.

According to the first aspect of the present invention, there is also provided a method of producing bread made from soybean flour as a main raw material. The method includes: mixing and kneading a mixture of raw materials containing soybean flour, yeast or a foaming agent, and water as main raw materials, containing neither wheat flour gluten nor silk fibroin and optionally containing a flavor improver or quality improver selected from the group consisting of sugars, oils and fats, milk products, egg, table salt, rice flour, barley flour, starch such as a starch powder, tapioca flour, or corn starch, and sorghum flour as a side raw material to prepare viscoelastic bread dough in a manner such that the mixed raw materials is dispersed and mixed uniformly, and that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water, thereby the bread dough having viscoelasticity with a viscosity of 1×10³ to 7.8×10⁴ (Pa·s) at a shear rate of 0.01 (/s); foaming and extending the obtained bread dough by fermentation action of the yeast or by foaming action of the foaming agent; shaping the foamed bread dough; and baking or steaming the shaped bread dough.

According to a second aspect of the present invention, there are provided a dough for foamed food comprising: sponge dough comprising a soft base dough obtained by way of adding and mixing 100 parts by weight of wheat flour, 100 to 140 parts by weight of water based on 100 parts by weight of wheat flour component, yeast or a foaming agent, and optionally water-soluble food fiber in a manner such that formation of a network structure of gluten is allowed to be promoted, thereby having sufficient viscoelasticity and shrinkage; and soybean dough comprising a mixture of raw materials containing soybean flour as a main raw material and optionally containing a part or all of water and a side raw material of flavor improver or quality improver, the raw materials being dispersed and mixed uniformly in a manner such that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water by way of mixing and kneading, thereby having a viscosity of 1×10³ to 2×10⁵ (Pa·s) at a shear rate of 0.01 (/s), the sponge dough and the soybean dough being mixed in a ratio such that an amount of the soybean flour is more than 50 parts by weight and an amount of the wheat flour is less than 50 parts by weight with a total of amounts of the soybean flour and the wheat flour being 100 parts by weight, and foamed food made from the dough.

In the second preferred aspect of the present invention, as stated above, there is provided a dough for foamed food, such as bread, that contains a small amount of wheat flour and a large amount of soybean flour, has no soybean odor, has a high nutritional value, and tastes good by way of using raw soybean flour, or defatted soybean flour, or both made from lipoxygenase-completely deficient soybean having no immature flavor as a raw material that is used in large amounts.

According to the second aspect of the present invention, there is also provided a sponge dough of a wheat raw material for foamed food containing soybean flour as a raw material comprising: a soft base dough obtained by way of adding and mixing 100 parts by weight of wheat flour, 100 to 140 parts by weight of water based on 100 parts by weight of wheat flour component, yeast or a foaming agent, and optionally water-soluble food fiber in a manner such that formation of a network structure of gluten is allowed to be promoted, thereby having sufficient viscoelasticity and shrinkage.

According to the second aspect of the present invention, there is also provided a desired soybean raw material dough to be mixed with a soft base dough of wheat flour as sponge dough comprising: a mixture of raw materials containing soybean flour and optionally containing a part or all of water and a side raw material of flavor improver or quality improver selected from the group consisting of sugars, oils and fats, milk products, egg, and the like, the raw materials being dispersed and mixed uniformly in a manner such that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water by way of mixing and kneading to prepare viscoelastic dough, thereby having a viscosity of 1×10³ to 2×10⁵ (Pa·s) at a shear rate of 0.01 (/s).

In the second preferred aspect of the present invention, further, there is obtained a soybean raw material dough with no immature flavor by way of using the soybean flour comprises raw soybean flour, or defatted soybean flour, or both made from a lipoxygenase-completely deficient soybean having no immature flavor used in large amount in the dough of soybean flour, which is to be mixed with the soft base dough of wheat flour as sponge dough.

Furthermore, according to the present invention, there is provided a method of producing foamed food, such as bread, containing a large amount of soybean flour. The method includes: preparing a sponge dough of a wheat raw material as a soft base dough by way of adding and mixing 100 parts by weight of wheat flour, 100 to 140 parts by weight of water based on 100 parts by weight of wheat flour component, yeast or a foaming agent, and optionally water-soluble food fiber in a manner such that formation of a network structure of gluten is allowed to be promoted, thereby having sufficient viscoelasticity and shrinkage; preparing a soybean dough comprising a mixture of raw materials containing soybean flour and optionally containing a part or all of water and a side raw material of flavor improver or quality improver, the raw materials being dispersed and mixed uniformly in a manner such that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water by way of mixing and kneading to prepare viscoelastic dough, thereby having a viscosity of 1×10³ to 2×10⁵ (Pa·s) at a shear rate of 0.01 (/s); subjecting the sponge dough of the wheat raw material according as a sponge to first fermentation (or foaming) to effect fermentation (or foaming) thereof sufficiently in advance; mixing the fermented sponge dough with the soybean dough; molding the resultant mixture; subjecting the molded mixture to second fermentation (or foaming); and treating the molded and fermented mixture by way of baking or steaming in an oven, heating in a microwave oven, or frying in oil, or the like.

In the second preferred aspect of the present invention, further, the fermentation in the aforementioned method of producing foamed food performs in a manner such that the volume of the dough increases to 2 to 4 times volume of the original dough in the first fermentation, the volume of the dough increases to 2.5 to 4.5 times volume of the original dough in the second fermentation, and the volume of the dough increases to 4 to 5 times volume of the original dough by way of baking or the like.

### BEST MODE FOR CARRYING OUT THE INVENTION

In the present specification and the claims, singular forms should be construed as also containing plural forms unless it is understood to the contrary from the context.

A first embodiment of the present invention is explained below. It has been considered that soybean flour, unlike wheat flour, contains substantially no gluten and no other viscoelastic substances, so that the soybean flour does not form a crosslinked network structure. However, the inventors of the present invention have made extensive studies and succeed to produce foamed food such as bread using soybean flour as a main raw material without using any wheat flour (or with using neither wheat flour gluten nor silk fibroin), a sponge-like crosslinked network structure being made formed.

On the other hand, according to a second embodiment of the present invention, the use of new blending technology makes it possible to form good sponge-like crosslinked network structure owing to the fermentation action by yeast or the foaming action by a foaming agent such as baking powder using a large amount of soybean flour as a main raw material, while the use having been conventionally considered to have difficulties, so that healthy foamed food including soybean's good palatability and making the best of heath components that soybean has can be produced with ease in the form of soybean bread, soybean doughnut, soybean bagel, soybean focaccia, soybean pizza, soybean buns, or the like.

Conventionally, wheat flour has been used as a raw material for foamed food such as bread. It has been known that this is ascribed to the gluten's viscoelasticity exhibited after the wheat flour is mixed with water. From the breadmaking properties of wheat flour, generally wheat flour is kneaded by adding water in a blending amount of from 40% by weight up to 70% by weight based on 100% by weight of the raw material of wheat flour to promote the formation of gluten. The viscoelastic properties of gluten are obtained by collision against each other of two proteins, i.e., gliadin and glutenin in a hydrated state during mechanical mixing so as to newly form a crosslinked network structure, such as an S—S-bond. When foams are formed, for example, by the action of yeast, due to the low viscosity with components other than the wheat flour gluten, the process of growth and deformation of air bubbles are promoted. Then, when the air bubbles having grown large, although the thickness of the wall of each of the air bubbles becomes thinner, skeletons with large air bubbles and a unique texture are generated because of the gluten component existing that maintains their structures without being crushed. However, the soybean flour contains substantially no gluten that can form a good crosslinked network structure unlike the wheat flour and contains no other viscoelastic substances. This has led to the belief that it is impossible to produce foamed food such as bread containing a large amount of soybean flour.

In the case of bread produced from conventional wheat flour as a main raw material, the viscosity of dough before fermentation by yeast can be made very high owing to the existence of gluten. However, the dough formed by; mixing and kneading soybean flour, yeast or a foaming agent such as baking powder, and water as main raw materials, and optionally side raw materials such as sugars, oils and fats, milk products, egg, table salt, and the other quality improvers or taste improvers, when made in a viscosity comparable with the conventional dough made of wheat flour as a main raw material, did not expand since desired fermentation or foaming did not proceed during the fermentation process by yeast or the foaming process with the foaming agent such as baking powder.

Recently, fundamental researches on the relationship between foam moldability and viscosity of plastics have been progressed in the different field of technology on the foam forming processes. The finding in the researches indicates that when materials have the similar characteristics in the viscosity, each of the materials will foam well independently on the molecular structure of the respective materials. The inventors of the present invention have made studies based on the academic views in the different kind of technical field, further with paying attention to the characteristics in the viscosity to achieve the object.

First, in the case of bread dough made of a main raw material of wheat flour, it is found that the viscosity of the dough at the time of fermentation is about 100,000 (Pa·s) at a shear rate of 0.01 (/s). Thus, since the bread dough made of a main raw material of wheat flour has a considerably high viscosity, the bread can be freely shaped depending on the kind of bread, for example, into rod, roll, or filled in a square box in the case of bread. Then, it has been found that the shaped bread dough can be passed through good foaming process by baker's yeast (yeast) or baking powder (foaming agent) to form a crosslinked network structure, which can be fixed by baking.

This gave an expectation that bread composed mainly of soybean flour and optionally of side materials added thereto has the same or conceptually close characteristics in the viscosity, and trials have been made to obtain such bread. However, when the bread dough composed mainly of soybean flour is made to have a viscosity as high as that of the conventional bread dough, no acceptable foaming ratio could be obtained. Accordingly, the inventors of the present invention have made it clear that when soybean flour is used as a main raw material, good foaming can be obtained by way of increasing the amount of water to be added to cause the dough to have a viscosity in a specified viscosity range suited for the material, that is, to make dough mainly composed of soybean flour have a viscosity of 1×10³ to 7.8×10⁴ (Pa·s), preferably 7×10³ to 5.2×10⁴ (Pa·s), at a shear rate of 0.01 (/s), the dough being foamed and expanded by the fermentation action of yeast. In addition, it has been found that, when the dough in such viscosity range has foamed and expanded through the foaming process by fermentation or foaming, the dough can form a sponge-like crosslinked network structure when baked, steamed or heated in a microwave oven, and the stricture can be fixed. The above-mentioned adjustment of viscosity can be performed by changing the amount of water to be added to the above-mentioned blending components as appropriate. One skilled in the art can perform such an adjustment with ease.

According to the present invention, the viscosity of the dough within the range of 1×10³ to 7.8×10⁴ (Pa·s) at a shear rate of 0.01 (/s) can be obtained by way of blending 100 parts by weight of soybean flour consisting of 65 to 100% by weight of dehulled soybeans, or raw soybean flour, or both and 0 to 35% by weight of defatted soybean flour with 70 to 140 parts by weight of water, with grinding conditions on processing soybean into soybean flour and the residual ratio of soybean oil being adjusted.

The inventors of the present invention have found that the utilization of new technological findings thus found enables one to provide a dough composed mainly of soybean flour for foamed food that performs good foaming by the fermentation by yeast or with a foaming agent such as baking powder, while the use of soybean flour as a main raw material having been considered to be difficult. Also, the inventors of the present invention have found that the use of such dough for foamed food enables one to produce with ease new foamed food such as soybean flour bread, soybean flour doughnut, soybean flour sponge cake, or soybean flour pizza utilizing the advantage of unique flavor of soybean flour, without using in particular viscous reinforcing materials such as wheat flour, gluten, purified silk fibroin, and high-molecular-weight viscous food. The present invention is intended to contribute to the creation of a wide variety of foods utilizing soybean flour as a main raw material that has unique flavor and taste, different from those of the wheat flour.

According to a first preferred embodiment of the present invention, to prepare viscoelastic dough having a viscosity within the above-mentioned range, it is preferable that yeast or a foaming agent be added in an amount of 0.5 to 5 parts by weight, more preferably 1.5 to 3.5 parts by weight and water be added in an amount of 70 to 150 parts by weight, more preferably 95 to 120 parts by weight, both based on 100 parts by weight of soybean flour to thereby adjust the viscosity of the dough. Note that when the flavor improver or quality improver is added, the blending amount thereof is not particularly limited. It may be blended in an amount of 45 parts by weight or less, preferably 5 to 45 parts by weight, more preferably 10 to 30 parts by weight, as necessary.

According to a first embodiment of the present invention, there is provided a method of producing a crosslinked network structure made of soybean flour as a main raw material. The method includes: mixing and kneading a mixture of raw materials containing soybean flour, yeast or a foaming agent such as baking powder, and water as main raw materials and optionally containing a quality improver or flavor improver as a side raw material to prepare viscoelastic dough in a manner such that the mixed raw materials is dispersed and mixed uniformly, thereby the dough having a viscosity of 1×10³ to 7.8×10⁴ (Pa·s) at a shear rate of 0.01 (/s); foaming and expanding the dough by fermentation action by yeast; and subjecting the resultant to a heat treatment.

The first embodiment provides a basic invention based on the findings that when the viscoelastic dough formed as a main raw material containing soybean flour, yeast or a foaming agent such as baking powder, and water is adjusted such that it has a viscosity of 1×10³ to 7.8×10⁴ (Pa·s) at a shear rate of 0.01 (/s), the dough can undergo good foaming and expansion by the fermentation action and that the heat treatment of the foamed dough can give rise to a crosslinked network structure with the soybean flour. In spite of the conventional belief that soybean flour will not form a sponge-like crosslinked network structure without the addition of a viscous reinforming material, the present invention has made it possible to realize such by simply adjusting the viscosity, which broadens utilization modes of soybean flour as food.

Also, the first embodiment of the present invention provides dough containing soybean flour as a main raw material for foamed food. The dough includes: a mixture of raw materials containing soybean flour, yeast or a foaming agent such as baking powder, and water as main raw materials and optionally containing a part or all of side raw materials such as sugars, oils and fats, milk products, egg, table salt, and the other quality improvers or taste improvers, the raw materials being dispersed and mixed uniformly by way of mixing and kneading to prepare viscoelastic dough, thereby having a viscosity of 1×10³ to 7.8×10⁴ (Pa·s) at a shear rate of 0.01 (/s).

The first embodiment of the present invention relates to foamable dough containing soybean flour as a main raw material for foamed food and having viscoelasticity. This is an intermediate processed product for cooking using the principle of the first embodiment of the present invention. As stated above, dough for foamed food having a viscosity range that is suitable for materials and different from that in the conventional wheat flour dough is advantageous since it can undergo a good foaming process with ease and can produce foamed food containing soybean flour as a main raw material.

The term “soybean flour” as used herein means soybean flour such as commercially available raw soybean flour and defatted soybean flour. Flour made from lipoxygenase-completely deficient soybean is more preferable since it does not have immature flavor and be more suitable for foamed food. Commercially available ground soybean that has been heat-treated can be used in small amounts. However, such ground soybean cannot be used as the soybean flour of a main raw material. Hereinafter, the present invention will be explained by centering on the case where raw soybean flour is used. On the other hand, when defatted soybean flour is used as the soybean flour, the viscosity of the defatted soybean flour can be adjusted to a desired viscosity by increasing the amount of water in the raw material composition as compared with the case in which raw soybean flour is used.

The first embodiment of the present invention provides dough for foamed food, in which the soybean flour used in the above-described dough for foamed food as a main raw material is soybean flour to which rice flour, barley flour, starch, or sorghum flour is added as a quality improver. Here, the rice flour may be commercially available joshinko (fine rice flour), joko (ordinary rice flour). Similarly, the barley flour refers to a commercially available one. Starches include katakuriko (starch), corn starch, and tapioca flour, and the sorghum flour is fine particle sorghum.

The first embodiment of the present invention further provides a powdery raw material for basic preparation to utilize for foamed food obtained by way of mixing a soybean flour raw material with table salt, powdery sugar and a powdery milk product in combination. This powdery raw material for basic preparation is a powdery basic prepared raw material to utilize for foamed food that is formulated as described above simply by way of combining the prepared soybean flour as raw material to utilize for foamed food with powdery raw materials such as the table salt, the powdery sugar, and the powdery milk product. When simply mixed, those will neither react with the soybean flour nor change the physical properties thereof. Therefore, when this form of the powdery raw material for basic preparation being commoditized, distributed or preserved until foamed food is to be produced, yeast, water, oils and fats, or egg is simply added, mixed and kneaded to provide dough for foamed food, thereby making the dough have suitable viscosity to allow foaming and expansion with ease by fermentation action of yeast or with a foaming agent such as baking powder, so that foamed food can be produced conveniently.

The first embodiment of the present invention provides a foamed food containing soybean flour as a main raw material. The foamed food is prepared by: preparing dough for foamed food including a mixture of raw materials containing soybean flour, yeast or a foaming agent, and water as main raw materials and optionally containing a part or all of side raw materials such as sugars, oils and fats, milk products, egg, table salt, and the other quality improvers or taste improvers, the raw materials being dispersed and mixed uniformly by way of mixing and kneading, thereby having a viscosity of 1×10³ to 7.8×10⁴ (Pa·s) at a shear rate of 0.01 (/s); foaming and expanding the dough for foamed food by fermentation action by yeast or by foaming with a foaming agent such as a baking powder; and heating the expanded dough by means of, for example, baking, steaming or heating in a microwave oven to form a crosslinked network structure.

The foamed food of the present invention as described above is foamed food that may include soybean flour bread, soybean flour doughnut, soybean flour castella, soybean flour sponge cake, and soybean flour pizza utilizing the advantage of unique flavor of soybean flour. As stated above, the present invention provides foamed food containing soybean flour as a main raw material that has a crosslinked network structure while it has been considered difficult to provide by using soybean flour as a main raw material, the soybean flour having unique flavor and taste different from those of wheat flour. Thus, the present invention finds a novel way of utilization leading to conversion of the soybean flour into food.

The first embodiment of the present invention provides a foamed food containing the above-mentioned soybean flour for the foamed food as a main raw material, the soybean flour containing the prepared soybean flour for foamed food, yeast, and water.

The first embodiment of the present invention provides a foamed food containing the above-mentioned soybean flour for the foamed food as a main raw material, the soybean flour containing rice flour, barley flour, starch, or sorghum flour as a quality improver.

The first embodiment of the present invention further provides bread containing soybean flour as a main raw material obtained by: preparing bread dough using a mixed raw material that simply includes soybean flour, yeast, and water as main raw materials and optionally a quality improver or a flavor improver with viscosity adjusting to become soft; foaming and expanding the bread dough by fermentation or foaming; and baking or steaming to form a crosslinked network structure. Such bread represents a mode of commercial product as foamed food containing soybean flour as a main raw material. Bread is very popular main food. However, the bread containing soybean flour as a main raw material according to the present invention contains no components that reinforce the viscoelasticity, such as wheat flour and gluten, so that it provides unique palatability and flavor different from those of the conventional wheat flour bread. That is, the present invention is successful in commercializing bread that is made from soybean flour, has new palatability unique to soybean and contains a large amount of healthy nutritional elements.

The first embodiment of the present invention further provides a method of producing bread containing soybean flour as a main raw material. The method includes: preparing bread dough including a mixture of raw materials containing soybean flour, yeast or a foaming agent such as a baking powder, water, and table salt as main raw materials and optionally containing a part or all of side raw materials such as sugars, oils and fats, milk products, egg, table salt, and the other quality improvers or taste improvers, the raw materials being dispersed and mixed uniformly by way of mixing and kneading, thereby having viscoelasticity with a viscosity of 1×10³ to 7.8×10⁴ (Pa·s) at a shear rate of 0.01 (/s); foaming and expanding the bread dough by fermentation; shaping the fermented dough; and baking or steaming the fermented dough.

The method or producing bread according to the first embodiment of the present invention provides a method of producing bread containing soybean flour as a main raw material with ease that has been considered to be difficult to achieve. That is, the method is convenient for production in a stable manner of foamed food such as bread, the bread having a sponge-like crosslinked network structure, in which bread dough is prepared by using main raw materials simply containing soybean flour, yeast, and water and adjusting its viscosity, followed by performing prior techniques of fermentation, shaping, and baking processes.

Hereinafter, a second embodiment of the present invention will be explained.

The inventors of the present invention have found that sufficient gluten forms even when greater amount of water (100 to 140 parts by weight) based on the wheat flour component (100 parts by weight) is used instead of using conventional amount of water. Thus, it is found that a good crosslinked network structure can be formed even with soft base dough having sufficient viscoelasticity and shrinkage, the soft base dough being obtained by using wheat flour raw material, greater amount of water than conventional one, yeast, and optionally water-soluble food fiber, thereby the formation of a network structure of gluten promoting.

The inventors of the present invention have previously found that breadmaking properties are not given only by the action of gluten but fermentable foamed food can be produced by adjusting the viscosity of the dough without using gluten (even with 100% rice flour) (cf. JP-A-2003-189786). Further, the inventors of the present invention have found that even when the amount of gluten formed from a wheat raw material is very small, the adjustment of the viscosity of the raw material to be added makes it possible to expand the dough owing to a large amount of bubbles contained therein formed, for example, by fermentation by yeast. And when the expanded dough is heated, foamed food such as bread having a crosslinked network structure can be produced.

Based on the new finding, the inventors of the present invention have made extensive studies on addition of soybean flour as an additional raw material to soft wheat flour base dough and have acknowledged that addition of soybean flour as it is results in breakage of once formed crosslinked network of gluten derived from wheat flour. Accordingly, after further study, it has now been found that the dough for foamed food can be mixed without breaking the crosslinked network of gluten in the soft base dough made of a wheat raw material having gluten constructed therein by: preparing dough including a mixture of raw materials containing soybean flour and water, and optionally containing a part or all of side raw materials such as sugars, oils and fats, milk products, egg, and the other quality improvers or taste improvers, the raw materials being dispersed and mixed uniformly by way of mixing and kneading, thereby having viscoelasticity.

When a large amount of soybean flour is charged from the first in the conventional method of producing dough for bread containing wheat flour as a main raw material before fermentation by yeast, the soybean flour prevents the formation of a newly crosslinked network structure such as an S—S bond generated by kneading a small amount of wheat gluten contained therein, so that the resultant dough does not have glutinous elasticity and when foamed by yeast, the thickness of the cell wall that contains a bubble can not be maintained since gluten was not formed. This results in insufficient progress of fermentation, causing no expansion, so that when baked, the dough gives hard, heavy bread.

In the second embodiment of the present invention, a method for promoting the formation of gluten from even a small amount of wheat has been considered. Since the skeleton of foamed food such as bread is gluten, when the tenacity of gluten being brought out as much as possible, it has been considered that a crosslinked network structure may be formed even only a small amount of wheat is used for a large amount of soybean flour introduced. In order to bring out gluten as much as possible, soybean flour dough and wheat flour dough are prepared independently. In a manner such that 100 parts by weight of wheat component are added with 90 to 140 parts by weight of water, and yeast and as necessary water-soluble food fiber, to form soft base dough having sufficient viscoelasticity and shrinkage, thereby the formation of gluten being promoted, wheat flour dough having formed therein a good crosslinked network structure can be produced.

The wheat dough in which a good crosslinked network structure is formed is subjected to first fermentation to strengthen the formed gluten. Then, a large amount of soybean flour is added to the wheat flour dough in which the strong crosslinked network structure is formed. If the soybean flour is added as it is in a large amount to the wheat flour dough, the gluten once formed will be broken again and no fermentation will occur. Accordingly, in the present invention, separately of the wheat dough, soybean dough is prepared. The soybean dough is a dough made of soybean flour as a main raw material characterized in that it includes: a mixture of raw materials containing soybean flour and optionally containing a part or all of water and side raw materials such as sugars, oils and fats, milk products, egg, starch (for example, starch, corn starch, or tapioca), sorghum flour, and the other quality improvers or taste improvers, the raw materials being dispersed and mixed uniformly by way of mixing and kneading to prepare viscoelastic dough, thereby having a viscosity of 1×10³ to 2×10⁵ (Pa·s) at a shear rate of 0.01 (/s). As stated above, such viscosity can be adjusted by blending 100 parts by weight of soybean flour consisting of 65 to 100% by weight of dehulled soybeans, or raw soybean flour, or both and 0 to 35% by weight of defatted soybean flour with 70 to 140 parts by weight of water.

A hundred to 140 parts by weight of water, yeast, and optionally water-soluble food fiber (for example, tamarind gum, guar gum, pectin substance, algae polysaccharides) are added to 100 parts by weight of wheat flour component and the formation of a network structure of gluten is promoted to form soft base dough having sufficient viscoelasticity and shrinkage, which is then added as sponge dough to soybean flour dough including: a mixture of raw materials containing soybean flour as a main raw material and optionally containing a part or all of water and a side raw material of sugars, oils and fats, milk products, egg, and the other flavor improver or quality improver, the raw materials being dispersed and mixed uniformly by way of mixing and kneading to prepare viscoelastic dough, thereby having a viscosity of 1×10³ to 2×10⁵ (Pa·s), preferably 9×10³ to 6×10⁴ (Pa s) at a shear rate of 0.01 (/s). Here, care must be taken, that is, the wheat flour dough and the soybean raw material dough is mixed in a manner such that the crosslinked network of gluten formed by the wheat flour dough of which formation of a small amount of gluten is promoted is not broken. Upon mixing, 50 parts by weight or more, preferably 70 to 95 parts by weight of the soybean flour and 50 parts by weight or less, preferably 30 to 5 parts by weight of the wheat flour (total of both is 100 parts by weight) are mixed. It has been found that this method makes it possible to produce good foamed food such as bread even when only a small amount of wheat is used.

According to a second preferred embodiment of the present invention, to prepare viscoelastic dough having a viscosity within the above-mentioned range, it is preferable that yeast or a foaming agent be added in an amount of 0.5 to 5 parts by weight, more preferably 1.5 to 3.5 parts by weight and water is added in an amount of 70 to 150 parts by weight, more preferably 100 to 125 parts by weight, both based on 100 parts by weight of the total of the wheat flour and the soybean flour to thereby adjust the viscosity of the dough. Note that when the flavor improver or quality improver is added, the blending amount thereof is not particularly limited. It may be blended in an amount of 45 parts by weight or less, preferably 5 to 45 parts by weight, more preferably 10 to 30 parts by weight, as necessary.

### EXAMPLE

Hereinafter, the present invention will be explained in more detail by way of examples. In the following examples, an example of preparing bread will be explained. However, the present invention should not be construed as being limited to the example of preparing bread.

### Examples 1 and 2 and Comparative Examples 1 to 4

Bread is usually prepared from wheat flour, yeast, table salt, and water as main components. And side raw materials such as sugars, oils and fats, milk products and egg may be used depending on the kind. Production process of bread is presented. First in a mixing and kneading step, the raw materials are dispersed and mixed uniformly to prepare dough for foamed food having a suitable elasticity and elongation properties and containing yeast for fermentation. Then, in a fermentation step, carbon dioxide is generated by the action of yeast to expand the dough. That is, a foamed material that is fermented and expanded by the foaming process by fermentation is prepared. The foamed material is shaped into various shapes depending on the kind of bread products and in a baking step, the foamed material dough is baked in an oven to produce bread.

Generally, bread is produced as described above, and it is known that there are a variety of methods for industrial production of bread. A representative method is a direct dough kneading method in which all the blending materials are kneaded simultaneously and then fermented. Another representative method is a sponge dough method, in which first sponge dough is prepared from only a part of the materials and fermented, the rest materials are added, and the resultant mixture is further kneaded to prepare dough, which is fermented. It is generally said that the latter production method is featured in that the residual amount of the components to be added to the dough can be controlled in the state after the sponge dough is fermented, so that the quality of products can be made uniform.

The composition containing soybean flour according to the present invention can be used to prepare good foamed food such as bread by either the direct dough kneading method or the sponge dough method, and any of the methods may be used. In the following examples and comparative examples, all the results shown below were obtained with a direct dough kneading method.

Hereinafter, the composition of each of the raw materials used for preparing bread of each of Examples 1 and 2 and Comparative Examples 1 to 4. Table 1 shows the composition of each of the raw materials of Comparative Examples 1 to 4, and Table II shows the composition of each of the raw materials of Examples 1 and 2.

TABLE I
Composition of each of raw materials
used in Comparative Examples 1 to 4

| | Wheat | Soybean | Ground | | Egg |
|---|---|---|---|---|---|
| Comparative | flour | flour | flour | Water | white |
| Example No. | (g) | (g) | (g) | (g) | (g) |
| Comparative | 75 | — | — | 10 | 30 |
| Example 1 | | | | | |
| Comparative | 75 | — | — | 30 | 30 |
| Example 2 | | | | | |
| Comparative | — | — | 75 | 68 | 31.5 |
| Example 3 | | | | | |
| Comparative | — | 40 | — | 68 | 31.5 |
| Example 4 | | | | | |

| | | Skimmed | | | |
|---|---|---|---|---|---|
| Comparative | Butter | milk powder | Sugar | Salt | Yeast |
| Example No. | (g) | (g) | (g) | (g) | (g) |
| Comparative | 8 | 8 | 8 | 1 | 2 |
| Example 1 | | | | | |
| Comparative | 8 | 8 | 8 | 1 | 2 |
| Example 2 | | | | | |
| Comparative | 8 | 8.5 | 4.5 | 1 | 1.25 |
| Example 3 | | | | | |
| Comparative | 8 | 8.5 | 4.5 | 1 | 1.25 |
| Example 4 | | | | | |

TABLE II
Composition of each of raw materials used for Examples 1 and 2

| | Soybean | Ground | | Egg |
|---|---|---|---|---|
| | flour | flour | Water | white |
| Example No. | (g) | (g) | (g) | (g) |
| Example 1 | 75 | — | 68 | 31.5 |
| Example 2 | 120 | — | 68 | 31.5 |

| | | Skimmed | | | |
|---|---|---|---|---|---|
| | | milk | | | |
| | Butter | powder | Sugar | Salt | Yeast |
| Example No. | (g) | (g) | (g) | (g) | (g) |
| Example 1 | 8 | 8.5 | 4.5 | 1 | 1.25 |
| Example 2 | 8 | 8.5 | 4.5 | 1 | 1.25 |

In Tables I and II, Golden Yacht manufactured by Nippon Flour Mills Co., Ltd. was used as a raw material of wheat flour. And “Tachiyutaka” and “Suzuyutaka” both manufactured in the prefecture of Yamagata were used as raw materials of soybean flour. Tachiyutaka and Suzuyutaka were ground to soybean flour (average particle size: 20 μm). Grinding was conducted by Origin Fuji Co., Ltd. and performed by body friction grinding generating less heat. As a raw material of ground soybean, commercially available ground green soybean (manufactured by Yoshida Seihun Co.) prepared with heating before the grinding was used. Hokkaido butter manufactured by Yotsuba Milk Industry Co., Ltd. was used as butter, and Skim milk manufactured by Yotsuba Milk Industry Co., Ltd. was used as skimmed milk powder. Sugar (Spoon Mark, white superior soft sugar) manufactured by Shin-Mitsui Sugar Co., was used as sugar. Enriched salt manufactured by Maruni Co., Ltd. was used as salt. Dry Yeast (instant dry yeast) manufactured by S. I. Lesaffre (France) was used as yeast.

The mixing and kneading were performed using a mixer (Kitchen Aid KSM 90 ww) manufactured by F.M.I. Co., Ltd. at room temperature for 15 minutes at maximum output. A mold having a size of 13.5 cm long, 6.8 cm wide, and 5.7 cm high was used, and dough was flew in the mold and fermented. Fermentation was performed for a fermentation time of 50 minutes at a temperature of about 35° C. While in the examples, butter was used. However, instead of butter, shortening or margarine may be used. Further, egg white may be replaced by egg containing yolk or by water. The yeast may be either dry yeast or wet yeast. A foaming agent such as baking powder may be added to the dough as necessary. As stated above, components other than the soybean flour as the main raw material may be general materials that are conventionally known. However, the soybean flour must be raw soybean flour, dehulled soybean flour, or defatted soybean flour. Heat-treated ground soybean may be used in small amounts. However, it is difficult to be used as a main raw material of soybean flour.

Then, the foaming ratio of the dough after the generation of foams by the fermentation action by the yeast was measured. The foaming ratio of the dough is an important index for defining the shape of bread. In this example, a material containing yeast before fermentation was flew in the mold and measured for height. This height was used as a standard. Then, the height of dough that has been fermented and baked was measured. From the ratio of the latter height to the former height, the foaming ratio of the dough was calculated. For example, a foaming ratio of 2 times means that the volume of the dough increased to twice while 1 time means that there is no change of volume before and after the fermentation.

The dough for foamed food containing soybean flour as a main raw material prepared by way of mixing and kneading the raw materials was measured for viscosity. The measurement of viscosity was performed using a rotary-type rheometer (tradename: ARES) manufactured by Rheometrix Co. For samples having high viscosities, a parallel plate type (with two disk plates between which a sample is placed, one (lower one) being rotated while another (upper one) detecting stress) was used. Experiments were conducted at room temperature in an atmosphere of air. For samples having low viscosities, a double cylinder type was used. A sample used for the measurement of viscosity was each of bread dough before fermentation prepared by mixing all the raw materials. The measurements were conducted under conditions of a constant strain speed (0.01/s) and a value of viscosity that reached almost stabilized value after about 700 seconds was used as a measured value. When samples have viscoelastic properties, it is generally known that the viscosity changes depending on the strain speed. In the present invention, since the speed of deformation accompanying fermentation is very slow, the viscosity at a very low deformation speed as low as 0.01 (/s) was considered to make a significant index for the viscosity characteristics of the material and thus defined as such. Upon preparing samples, the following was taken into consideration. When the samples contained yeast, bubbles were generated and grew during storage at room temperature or during measurement at room temperature to make it difficult to perform exact measurement. Therefore, among the compositions shown in Tables I and II above, corresponding compositions without yeast were provided and used exclusively as samples for measuring viscosity. This gave results of measurement of viscosity with reproducibility.

The composition of each of the raw materials used in Comparative Examples 1 to 4 was as shown in Table I and the results obtained are shown in Table III.

TABLE III
Summary of results of Comparative Examples

| | Foaming | | | |
|---|---|---|---|---|
| Comparative | ratio | Viscosity | | |
| Example No. | (times) | (Pa · S) | Shape | Palatability |
| Comparative | 3.4 | 1.1 × 10⁵ | Soft and | Heavy bread |
| Example 1 | | | elastic though | |
| | | | stuffed | |
| Comparative | 4.9 | 5.4 × 10⁴ | Bubbles | Soft |
| Example 2 | | | expanded too | |
| | | | much | |
| Comparative | 1.4 | 9.0 × 10⁴ | Stuffed and | Hard |
| Example 3 | | | almost no | |
| | | | expansion | |
| Comparative | 1.6 | 1.1 × 10² | Bubbles | Sticky |
| Example 4 | | | expanded too | |
| | | | much | |

It was possible to control the viscosity of conventional bread dough made of wheat flour as a raw material (Comparative Examples 1 and 2) with a small amount of water to some extent. Even with a very high viscosity as high as 1.1×10⁵ Pa·s or 5.4×10⁴ Pa·s, high foaming ratio of 3.4 times or 4.9 times is provided, respectively, so that the production of good bread was attained in this range.

The bread dough containing commercially available ground green soybean that was heat-treated (under conditions: soybean was heated before grinding processing) used as the raw material soybean had a very low foaming ratio (1.4 times) so that the dough was not suited for forming the structure of bread. Further, it gave poor palatability since it was too hard.

Further, the bread dough containing soybean flour as a main raw material but in an extremely small amount (Comparative Example 4) showed a very low viscosity. In this case, the viscosity was too low to maintain the structure of each bubble during the generation and growth thereof, so that foaming was poor (foaming ratio: 1.6 times).

Then, the compositions of the raw materials used in Examples and 2 are as shown in Tables II and the results of Examples and 2 are shown in Table IV below.

TABLE IV
summary of Examples

| | Foaming | | | |
|---|---|---|---|---|
| | ratio | Viscosity | | |
| Example No. | (times) | (Pa · S) | Shape | Palatability |
| Example 1 | 3.2 | 1.2 × 10⁴ | Plump bread | Smooth |
| Example 2 | 4.5 | 4.5 × 10⁴ | Plump bread | Smooth |

With the soybean flour ground by body friction causing no heating, which was used in each of Examples 1 and 2 and Comparative Example 3 as the soybean powder, the foaming ratio of the dough was 3.2 times and good bread was produced as shown in Example 1.

Further, in Example 2 in which the dough was prepared by increasing the amount of the raw material of soybean flour and also increasing the viscosity of the dough, the foaming ratio of the dough was 4.5 times so that plump and good bread was prepared. In this manner, when the viscosity of the prepared dough is within the range of the present invention, good bread can be prepared. This viscosity may depend on the ratio of the soybean flour to water or the kind of the soybean flour. In this case, raw soybean flour can give better dough. Since defatted soybean flour has flour characteristics different from those of raw soybean flour, so that the moisture ratio of the defatted soybean flour is different from the moisture ratio of the raw soybean flour. However, either of them can make good bread through the adjustment of the viscosity of the dough.

### Example 3

Bread was produced as follows using dough A and dough B having formulations shown in Table V.

TABLE V

| | Wheat | Soybean | Wheat | | Egg |
|---|---|---|---|---|---|
| | flour | flour | gluten | Water | white |
| | (g) *¹ | (g) *² | (g) *³ | (g) | (g) *⁴ |
| Dough A | 170 | — | 30 | 220 | 20 |
| (%) | (36.6) | (—) | (6.5) | (47.4) | (4.3) |
| Dough B | — | 800 | — | 280 | 240 |
| (%) | (—) | (53.7) | (—) | (18.8) | (16.1) |

| | | Skimmed | | | Dry |
|---|---|---|---|---|---|
| | Tamarind | milk powder | Sugar | Salt | yeast |
| | (g) *⁵ | (g) *⁶ | (g) *⁷ | (g) *⁸ | (g) ⁺⁹ |
| Dough A | 4 | — | — | — | 20 |
| (%) | (0.9) | (—) | (—) | (—) | (4.3) |
| Dough B | — | 80 | 80 | 9.6 | — |
| (%) | — | (5.4) | (5.4) | (0.6) | — |

*¹ Golden Yacht manufactured by Nippon Flour Mills Co., Ltd.
*² Bigole P (lipoxygenase-completely deficient soybean Elstar) manufactured by Safetech International.
*³ Wheat protein manufactured by Hokkoku Food Co., Ltd.
*⁴ Frozen egg white (for confectionery) manufactured by Q.P. Corporation.
*⁵ Glyloid 3S manufactured by Dainippon Pharmaceutical Co., Ltd.
*⁶ Defatted powdered skimmed milk manufactured by Yotsuba Milk Industry Co., Ltd.
*⁷ Spoon Mark white superior soft sugar manufactured by Shin-Mitsui Sugar Co.
*⁸ Enrich manufactured by Maruni Co., Ltd.
*⁹ Instant dry yeast from Nichifutsu Shoji Co., Ltd.

First, dough A having the formulation shown in Table V was mixed for about 10 to 15 minutes to form gluten well. On the other hand, dough B having the formulation shown in Table V was mixed for about 10 to 15 minutes to obtain well-mixed dough B. The dough A having formed gluten firmly was mixed with the well-mixed dough B and the resultant dough was kneaded in such manner that breakage of gluten does not occur. Finally, molten butter was charged and the resultant mixture was mixed by hand. Wheat flour was powdered on the kneaded dough and then the dough was left to stand for about 20 minutes to promote fermentation (fermentation time: 30 to 40 minutes), and then dividing-molded. The obtained dough was baked at a low temperature of 150° C. for 60 to 70 minutes so that the inside was baked thoroughly. This is because the periphery of the dough with soybean being present tends to be scorched and turned black.

The obtained bread formed cells as those in bread. But it was not to be believed to contain 80% of soybean, giving bread-like comfortable palatability.

### INDUSTRIAL APPLICABILITY

As stated above, according to the first embodiment of the present invention, foamed food such as bread containing soybean flour as a main raw material without using wheat flour can be provided in the market. On the other hand, according to the second embodiment of the present invention, a good crosslinked network structure can be formed even when the amount of wheat flour to be used for bread dough is decreased to less than 50 parts by weight while the amount of the soybean flour to be used for the bread dough is increased to more than 50 parts by weight, so that foamed food such as bread containing a large amount of soybean flour having soybean flour flavor and nutritional elements can be obtained.

1. A method of producing a crosslinked network structure made from soybean flour as a main raw material comprising:
mixing and kneading a mixture of raw materials containing soybean flour, yeast or a foaming agent, and water as main raw materials, containing neither wheat flour gluten nor silk fibroin and optionally containing a flavor improver or quality improver as a side raw material to prepare viscoelastic dough in a manner such that the mixed raw materials is dispersed and mixed uniformly, and that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water, thereby the dough having a viscosity of 1×10³ to 7.8×10⁴ (Pa·s) at a shear rate of 0.01 (/s);
foaming and extending the obtained dough by fermentation action of the yeast or by foaming action of the foaming agent; and
subjecting the foamed and extended dough to a heat treatment.

2. A method according to claim 1, wherein the flavor improver or quality improver is selected from the group consisting of sugars, oils and fats, milk products, egg, table salt, rice flour, barley flour, starch, and sorghum flour.

3. A viscoelastic dough containing soybean flour as a main raw material for foamed food comprising:
a mixture of raw materials containing soybean flour, yeast or a foaming agent, and water as main raw materials, containing neither wheat flour gluten nor silk fibroin and optionally containing a flavor improver or quality improver as a side raw material, the raw materials being dispersed and mixed uniformly in a manner such that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water by way of mixing and kneading, thereby having a viscosity of 1×10³ to 7.8×10⁴ (Pa·s) at a shear rate of 0.01 (/s),
wherein the flavor improver or quality improver is selected from the group consisting of sugars, oils and fats, milk products, egg, table salt, rice flour, barley flour, starch, and sorghum flour.

4. A powdery raw material for basic preparation comprising:
soybean flour as raw material; and
at least one member selected from the group consisting of table salt, powdered sugars, powdered milk products, powdered oils and fats, powdered egg, rice flour, barley flour, starch, and sorghum flour as a flavor improver or quality improver in combination with the soybean flour as raw material containing neither wheat flour gluten nor silk fibroin.

5. A foamed food containing soybean flour as a main raw material obtained by way of: foaming and expanding the dough for foamed food according to claim 3 by fermentation action by yeast or foaming action by a foaming agent; then molding the resultant; and subjecting the resultant to a heat treatment to form a crosslinked network structure.

6. A foamed food containing soybean flour as a main raw material according to claim 5, wherein the flavor improver or quality improver is selected from the group consisting of sugars, oils and fats, milk products, egg, table salt, rice flour, barley, starch, and sorghum flour.

7. A foamed food according to claim 5, wherein the foamed food is bread, and wherein the heat treatment after the foaming and expansion is performed by way of baking or steaming to form a sponge-like crosslinked network structure.

8. A dough for foamed food comprising:
sponge dough comprising a soft base dough obtained by way of adding and mixing 100 parts by weight of wheat flour, 100 to 140 parts by weight of water based on 100 parts by weight of wheat flour component, yeast or a foaming agent, and optionally water-soluble food fiber in a manner such that formation of a network structure of gluten is allowed to be promoted, thereby having sufficient viscoelasticity and shrinkage; and
soybean dough comprising a mixture of raw materials containing soybean flour as a main raw material and optionally containing a part or all of water and a side raw material of flavor improver or quality improver, the raw materials being dispersed and mixed uniformly in a manner such that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water by way of mixing and kneading, thereby having a viscosity of 1×10³ to 2×10⁵ (Pa·s) at a shear rate of 0.01 (/s),
the sponge dough and the soybean dough being mixed in a ratio such that an amount of the soybean flour is more than 50 parts by weight and an amount of the wheat flour is less than 50 parts by weight with a total of amounts of the soybean flour and the wheat flour being 100 parts by weight.

9. A dough for foamed food according to claim 8, wherein the soybean flour comprises raw soybean flour, or defatted soybean flour, or both made from a lipoxygenase-completely deficient soybean having no immature flavor.

10. A foamed food made from the dough for foamed food according to claim 8.

11. A foamed food according to claim 10, wherein the soybean flour comprises raw soybean flour, or defatted soybean flour, or both made from a lipoxygenase-completely deficient soybean having no immature flavor.

12. A sponge dough of a wheat raw material for foamed food containing soybean flour as a raw material comprising:
a soft base dough obtained by way of adding and mixing 100 parts by weight of wheat flour, 100 to 140 parts by weight of water based on 100 parts by weight of wheat flour component, yeast or a foaming agent, and optionally water-soluble food fiber in a manner such that formation of a network structure of gluten is allowed to be promoted, thereby having sufficient viscoelasticity and shrinkage.

13. A soybean raw material dough for mixing with a sponge dough of a wheat raw material for foamed food containing soybean flour, the soybean raw material dough comprising:
a mixture of raw materials containing soybean flour and optionally containing a part or all of water and a side raw material of flavor improver or quality improver, the raw materials being dispersed and mixed uniformly in a manner such that 100 parts by weight of soybean flour consisting of 65 to 100% by weight of soybean flour of dehulled soybeans, or raw soybean flour, or both and 0 to 35% by weight of defatted soybean flour blends with 70 to 140 parts by weight of water by way of mixing and kneading, thereby having a viscosity of 1×10³ to 2×10⁵ (Pa·s) at a shear rate of 0.01 (/s).

14. A soybean raw material dough according to claim 13, wherein the soybean flour comprises raw soybean flour, or defatted soybean flour, or both made from a lipoxygenase-completely deficient soybean having no immature flavor.

15. A method of producing foamed food containing a large amount of soybean flour comprising:
subjecting the sponge dough of the wheat raw material according to claim 12 as a sponge to first fermentation to effect fermentation thereof sufficiently in advance;
mixing the fermented sponge dough with a soybean raw material dough comprising a mixture of raw materials containing soybean flour, the flour comprising raw soybean flour, or defatted soybean flour, in both made from a lipoxygenase-completely deficient soybean having no immature flavor, and optionally containing a part or all of water and a side raw material of flavor improver or quality improver, the raw materials being dispersed and mixed uniformly in a manner such that 100 by weight of soybean flour consisting of 65 to 100% by weight of soybean flour of dehulled soybean, or raw soybean flour or both and 0 to 35% of defatted soybean flour blended with 70 to 140 parts by weight of water by way of mixing and kneading, thereby having a viscosity of 1×10³ to 2×10⁵ (Pa·s) at shear rate of 0.01 (/s);
molding the resultant mixture;
subjecting the molded mixture to second fermentation; and
treating the molded and fermented mixture by way of baking or steaming in an oven, heating in a microwave oven, or frying in oil.

16. A method of producing foamed food according to claim 15, wherein the soybean flour comprises raw soybean flour, or defatted soybean flour, or both made from a lipoxygenase-completely deficient soybean having no immature flavor.

17. A foamed food according to claim 6, wherein the foamed food is bread, and wherein the heat treatment after the foaming and expansion is performed by way of baking or steaming to form a sponge-like crosslinked network structure.
